(19) United States
(12) Patent Application Publication
(10) Pub. No.: US 2015/0244186 A1
(43) Pub. Date: Aug. 27, 2015

(54) POWER SUPPLY DEVICE

(71) Applicants: MAKITA CORPORATION, Anjo-shi (JP); ROHM CO., LTD., Kyoto-shi (JP); AQUAFAIRY CORPORATION, Kyoto (JP)

(72) Inventors: Takuya UMEMURA, Anjo-shi (JP); Yoshinori MIYAMAE, Kyoto-shi (JP); Hiroshi MIURA, Kyoto-shi (JP); Hitoshi ISHIZAKA, Kyoto-shi (JP)

(21) Appl. No.: 14/631,476

(22) Filed: Feb. 25, 2015

(30) Foreign Application Priority Data
Feb. 25, 2014 (JP) 2014-034156

(51) Int. Cl. H02J 7/00; H02J 7/34; H01M 10/44; H01M 10/46; H01M 8/04; H01M 16/00

(52) U.S. Cl. CPC H02J 7/007; H01M 8/04373; H01M 8/04656; H01M 16/006; H01M 10/443; H01M 10/46; H01M 8/04947; H02J 7/0068; H02J 7/34

(57) ABSTRACT

A power supply device comprises: a fuel cell configured to generate electric power by causing an oxidation reaction between a fuel and an oxidant; a rechargeable battery that is chargeable and dischargeable; a temperature detection unit configured to detect a temperature of the rechargeable battery; an output unit configured to externally output electric power; and a control unit configured to be capable of controlling at least one electric power of an input power to be inputted to the rechargeable battery from the fuel cell and an output power to be outputted from the rechargeable battery, based on a detected temperature detected by the temperature detection unit.

### CROSS-REFERENCE TO RELATED APPLICATIONS

This application claims the benefit of Japanese Patent Application No. 2014-034156 filed Feb. 25, 2014 in the Japan Patent Office, the entire disclosure of which is incorporated herein by reference.

### BACKGROUND

The present invention relates to a power supply device that comprises a fuel cell as a power source.

For example, Unexamined Japanese patent application publication No. 2011-212792 describes a power supply device that is provided with, as a power source, a fuel cell and a rechargeable battery. As in the case of this device, a power supply device comprising a fuel cell is generally provided with a rechargeable battery.

### SUMMARY

In one aspect of the present invention, it is desired in a power supply device comprising a fuel cell and a rechargeable battery to inhibit a battery lifespan of the rechargeable battery from being shortened.

Moreover, one aspect of the present invention is made by focusing on the following feature: if the rechargeable battery is used within an appropriate temperature range, a battery lifespan of the rechargeable battery can be inhibited from being shortened.

A power supply device according to one aspect of the present invention comprises: a fuel cell configured to generate electric power by causing an oxidation reaction between a fuel and an oxidant; a rechargeable battery that is chargeable and dischargeable; a temperature detection unit configured to detect a temperature of the rechargeable battery; an output unit configured to externally output electric power; and a control unit configured to be capable of controlling at least one electric power of an input power to be inputted to the rechargeable battery from the fuel cell and an output power to be outputted from the rechargeable battery, based on a detected temperature detected by the temperature detection unit.

With the aforementioned configuration, the present invention makes it possible to inhibit a shorter battery lifespan of the rechargeable battery.

### BRIEF DESCRIPTION OF THE DRAWINGS

The present invention will now be described by way of example with reference to the accompanying drawings, in which:

FIG. 1 is a block diagram showing a power supply device according to a first embodiment of the present invention;

FIG. 2 is a view showing an appearance of the power supply device according to the first embodiment of the present invention;

FIG. 3 is a flowchart of a power supply control in the power supply device according to the first embodiment of the present invention;

FIG. 4 is a flowchart of a power supply control in a power supply device according to a second embodiment of the present invention;

FIG. 5 is a view showing an appearance of a power supply device according to a third embodiment of the present invention;

FIG. 6 is a block diagram showing a power supply device according to a fourth embodiment of the present invention; and

FIG. 7 is a flowchart of a power supply control in a power supply device according to a fifth embodiment of the present invention.

### DETAILED DESCRIPTION OF THE PREFERRED EMBODIMENTS

### First Embodiment

1. A Schematic Configuration of a Power Supply Device

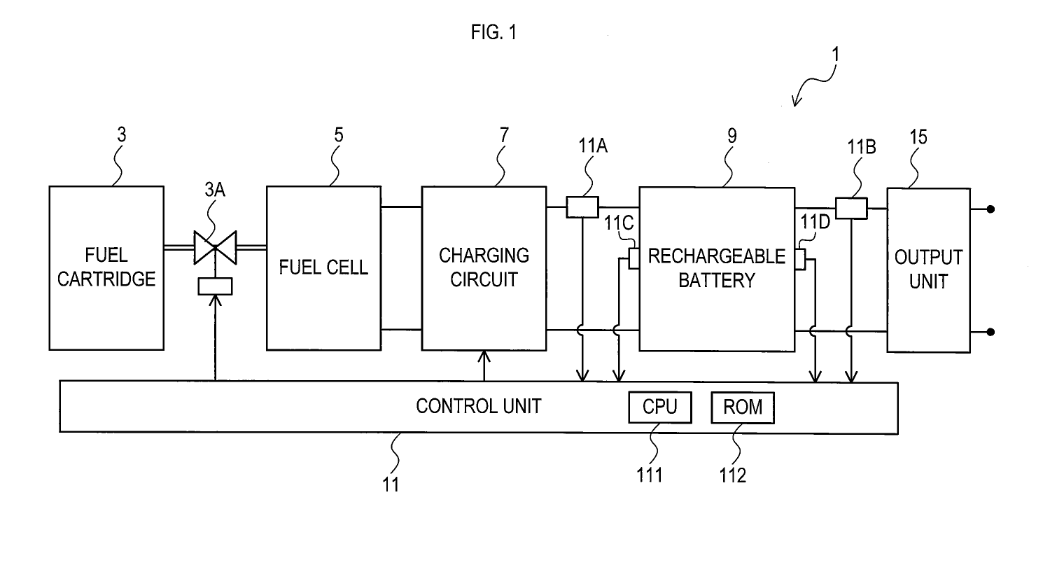

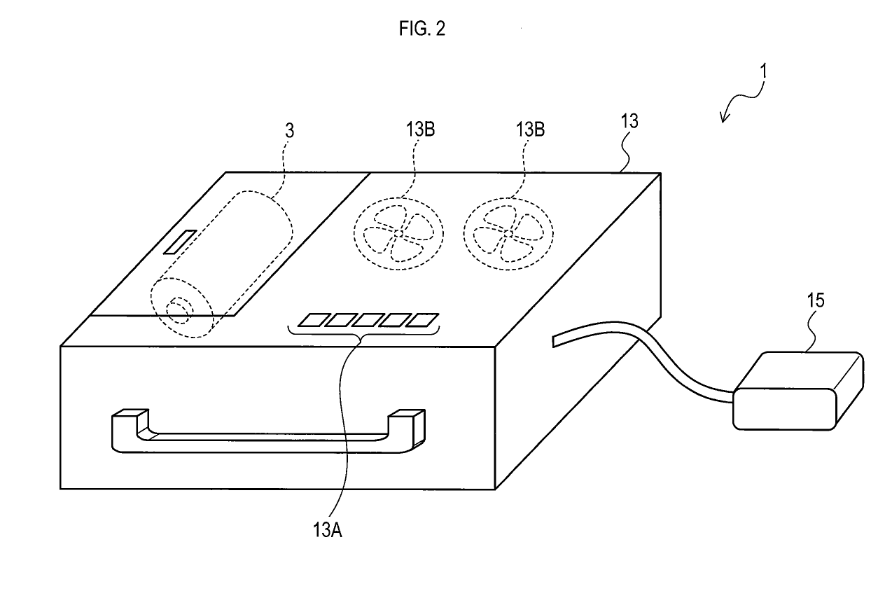

As shown in FIG. 1, a power supply device 1 comprises a fuel cartridge 3, a fuel cell 5, a charging circuit 7, a rechargeable battery 9, a control unit 11, and others. The components such as the fuel cartridge 3, etc. are accommodated in a casing 13, which is shown in FIG. 2. The fuel cartridge 3 is filled with fuel to be supplied to the fuel cell 5.

The fuel cartridge 3 is configured to be detachably attached to the casing 13. When the fuel that has been filled in the fuel cartridge 3 is used up, this fuel cartridge 3 is, not replenished with fuel, but replaced with a new fuel cartridge 3.

The casing 13 comprises an air inlet 13A for drawing in air. The air drawn through the air inlet 13A is supplied as an oxidant to the fuel cell 5, and also sent as a cooling air to the fuel cell 5, the rechargeable battery 9, etc. Then, the air that has been used for cooling the fuel cell 5, etc. is discharged to outside by a fan 13B.

An output unit 15 shown in FIG. 1 is configured to output electric power to an external load, such as an electric power tool. For this reason, the output unit 15 comprises a connection port for electrical connection to the external load such as an electric power tool. The fuel cell 5 is configured to generate electric power by causing an oxidation reaction between fuel and oxidant.

The fuel cell 5 according to the present embodiment is a direct methanol fuel cell (DMFC) that directly supplies, not a reformed fuel (hydrogen), but a liquid fuel (methanol) stored in the fuel cartridge 3. In the present embodiment, the fuel cell 5 does not comprise a pump or the like that feeds the fuel; the fuel is to be supplied by using a differential pressure between a pressure inside the fuel cartridge 3 and a pressure inside the fuel cell 5.

The rechargeable battery 9 is a chemical cell that can be charged and discharged. In the present embodiment, a lithium-ion battery is employed as the rechargeable battery 9. The charging circuit 7 controls input power to be inputted to the rechargeable battery 9 from the fuel cell 5. A solenoid valve 3A adjusts an amount of the fuel to be supplied to the fuel cell 5 from the fuel cartridge 3.

The control unit 11 controls operations of the solenoid valve 3A and the charging circuit 7. In the present embodiment, with this control of the operations of the solenoid valve 3A and the charging circuit 7 by the control unit 11, output power to be outputted from the fuel cell 5 is controlled. In the embodiments described hereinafter, electric power that is outputted to the rechargeable battery 9 via the charging circuit 7 is also referred to as “output power to be outputted from the fuel cell 5”.

The control unit 11 is configured with a microcomputer comprising a CPU, a ROM, a RAM, etc. Programs, etc. for controlling the operation of the solenoid valve 3A and the charging circuit 7 are pre-stored in a non-volatile memory unit, such as a ROM 112. A CPU 111 reads the programs, etc. stored in the ROM 112, etc. to execute control of the solenoid valve 3A, etc.

A first current meter 11A is configured to detect a value of electric current that has been outputted from the charging circuit 7 to the rechargeable battery 9. A second current meter 11B is configured to detect a value of electric current that is to be outputted to the external load from the output unit 15. A thermometer 11C is a temperature detection unit configured to detect a temperature Tb of the rechargeable battery 9.

A voltmeter 11D is configured to detect a voltage of the rechargeable battery 9. The control unit 11 and the solenoid valve 3A, as well as the first current meter 11A, the second current meter 11B, the thermometer 11C, and the voltmeter 11D operate by receiving power supply from the rechargeable battery 9.

Detected values detected by the first current meter 11A, the second current meter 11B, the thermometer 11C, and the voltmeter 11D are inputted to the control unit 11. The voltmeter 11D is configured to be a remaining energy detection unit; the remaining energy detection unit detects electric power that the rechargeable battery 9 can output, i.e., a remaining energy of the rechargeable battery 9.

2. Output control of the fuel cell, etc.

2.1 Overview of the control

The control unit 11 executes a control mode for maintaining the temperature Tb of the rechargeable battery 9 within a specified temperature range (for example, from 0° C. or more to 50° C. or less). Specifically, based on a detected temperature T1 detected by the thermometer 11C, the control unit 11 controls at least one electric power of the input power to be inputted to the rechargeable battery 9 from the fuel cell 5 and output power to be outputted from the rechargeable battery 9.

In the power supply device 1 according to the present embodiment, an opening degree of the solenoid valve 3A, i.e., an amount of fuel to be supplied to the fuel cell 5, is adjusted, thereby indirectly controlling at least one of the input power to be inputted to the rechargeable battery 9 from the fuel cell 5 and the output power to be outputted from the rechargeable battery 9.

If the opening degree of the solenoid valve 3A becomes greater, the amount of the fuel to be supplied to the fuel cell 5 increases, which increases the output power to be outputted from the fuel cell 5. On the other hand, if the opening degree of the solenoid valve 3A becomes smaller, the amount of the fuel supplied to the fuel cell 5 decrease, which decreases the output power to be outputted from the fuel cell 5.

In the description hereinafter, the output power to be outputted from the fuel cell 5 coincides with the input power inputted to the rechargeable battery 9. The control unit 11 determines an amount of electric power, such as the output power, the input power, and so on, by using the value of the electric current detected by the first current meter 11A or the second current meter 11B. This is because, the greater the value of the electric current becomes, the greater the electric power becomes.

Electric power outputted from the output unit 15 (hereinafter, referred to as “external output”) is a sum of electric power supplied from the rechargeable battery 9 (hereinafter, referred to as “battery output”) and electric power supplied from the fuel cell 5 (hereinafter, referred to as “FC output”).

The control unit 11 determines an amount of the FC output by using a first current value i1 detected by the first current meter 11A, and also determines an amount of the external output by using a second current value i2 detected by the second current meter 11B.

The control unit 11 determines a value obtained by subtracting the FC output from the external output, as the battery output. In this case, if the external output is greater than the FC output, i.e., if the first current value i1 is smaller than the second current value i2, the control unit 11 determines that it is a state where both the fuel cell 5 and the rechargeable battery 9 supply respective electric powers to the output unit 15.

If the external output is equal to the FC output, in other words, if the first current value i1 is equal to the second current value i2, the control unit 11 determines that it is a state where only the fuel cell 5 supplies electric power to the output unit 15 and the rechargeable battery 9 does not supply electric power to the output unit 15. Accordingly, the remaining energy of the rechargeable battery 9 does not decrease.

If the external output is smaller than the FC output, i.e., if the first current value i1 is greater than the second current value i2, the control unit 11 determines that it is a state where the fuel cell 5 supplies electric power to the output unit 15 and also to the rechargeable battery 9, and the rechargeable battery 9 is being charged.

As described above, the control unit 11 determines which state of the above-described three states it is currently in, by determining whether a differential current value i3, which is a difference between the first current value i1 and the second current value i2, is positive, zero, or negative. The differential current value i3 is a physical quantity that corresponds to the battery output.

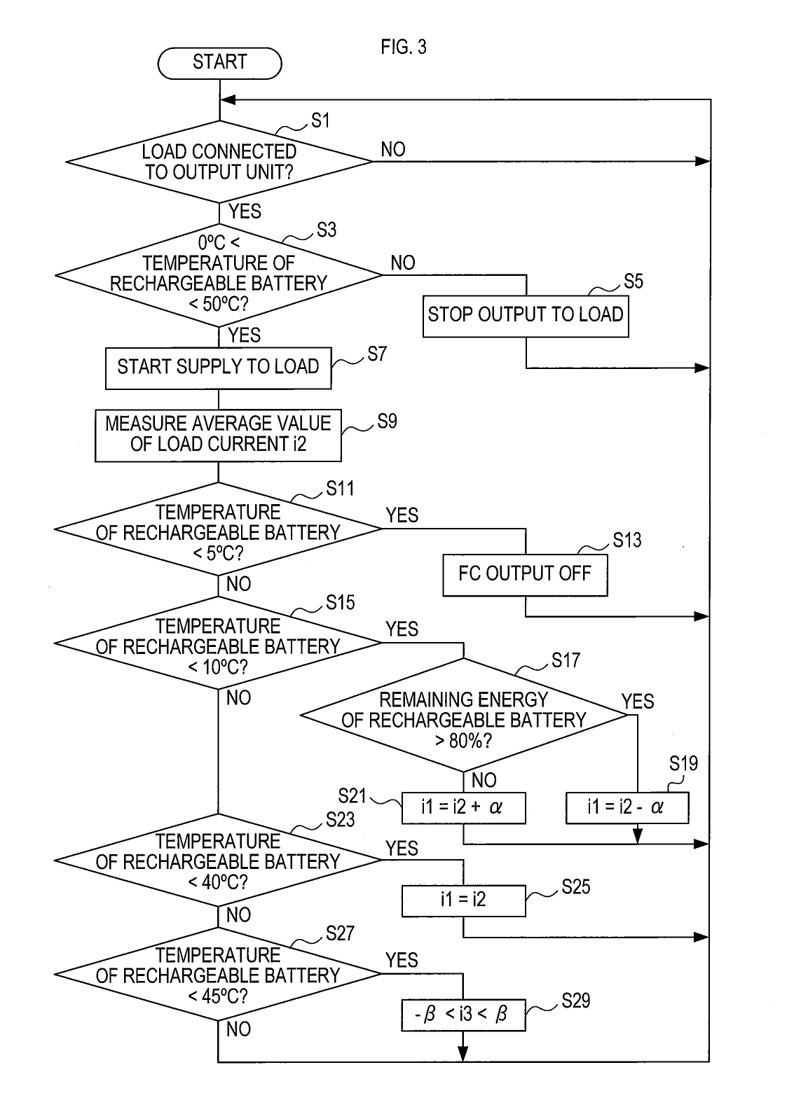

2.2 Details of control (see FIG. 3)

The flowchart in FIG. 3 shows a control (hereinafter, referred to as “power-supply control”). A program for this power-supply control is pre-stored in the non-volatile memory unit. When the CPU 111 reads the program for the power-supply control upon turn-on of an activation switch (not shown) of the power supply device 1, the program for the power-supply control is started. When the activation switch is interrupted, at that point in time, execution of the program for the power-supply control is stopped.

When the program for the power-supply control is started, it is determined whether an external load such as an electric power tool is connected to the output unit 15, in other words, whether the external output is being outputted (S1). If the external output is not being outputted (Si: NO), the step of S1 is carried out again and the power supply device 1 is made to be in a standby state.

If it is determined that the external output is being outputted (Si: YES), it is determined whether the temperature Tb of the rechargeable battery 9 is within a specified temperature range (0° C<Tb<50° C.) by using the detected temperature T1 of the thermometer 11C (S3).

If it is determined that the temperature Tb of the rechargeable battery 9 is out of the specified temperature range (S3: NO), the output unit 15 is stopped to stop the external output (S5), and such stop is notified to a user via a notifying unit (not shown), such as a lamp, a display, or a buzzer.

If it is determined that the temperature Tb of the rechargeable battery 9 is within the specified temperature range (S3: YES), the external output is outputted to supply electric power to the external load (S7); also, an average value of the second current value i2, i.e., the external output, is detected (S9).

Next, the control unit 11 determines whether the temperature Tb of the rechargeable battery 9 is less than a pre-set first specified temperature (10° C. in the present embodiment), and whether the temperature Tb of the rechargeable battery 9 is less than a pre-set second specified temperature (5° C. in the present embodiment), in the following manner.

It is determined whether the temperature Tb of the rechargeable battery 9 is less than the second specified temperature (5° C.) by using the detected temperature T1 (S11). If it is determined that the temperature Tb of the rechargeable battery 9 is less than the second specified temperature (5° C.) (S11: YES), the solenoid valve 3A is closed to stop fuel supply to the fuel cell 5, thereby stopping the supply of electric power to the rechargeable battery 9 from the fuel cell 5 (S13).

In S13, the supply of electric power from the fuel cell 5 stops and thus, only the rechargeable battery 9 supplies electric power to the external load. For this reason, a heat-generation amount of the rechargeable battery 9 increases, and the temperature Tb of the rechargeable battery 9 gradually increases.

If it is determined that the temperature Tb of the rechargeable battery 9 is equal to or greater than the second specified temperature (5° C.) (S11: NO), it is determined whether the temperature Tb of the rechargeable battery 9 is less than the first specified temperature (10° C.) (S15).

If it is determined that the temperature Tb of the rechargeable battery 9 is less than the first specified temperature (10° C.) (S15: YES), it is determined whether the remaining energy of the rechargeable battery 9 is greater than a specific remaining energy (for example, 80% of a fully-charged state) that is specified beforehand, by using a voltage detected by the voltmeter 11D (S17).

If it is determined that the remaining energy of the rechargeable battery 9 is greater than the specific remaining energy (S17: YES), the opening degree of the solenoid valve 3A is adjusted, such that the FC output, i.e., the input power to be inputted to the rechargeable battery 9, is equal to electric power obtained by subtracting a specified electric power from the current output power (S19). Specifically, the control unit 11 controls the solenoid valve 3A such that the first current value i1 is equal to an electric current value obtained by subtracting a specified current value α from the second current value i2.

If it is determined that the remaining energy of the rechargeable battery 9 is equal to or less than the specific remaining energy (S17: NO), the opening degree of the solenoid valve 3A is adjusted, such that the input power to be inputted to the rechargeable battery 9 is equal to electric power obtained by adding the specified electric power to the current output power (S21). Specifically, the control unit 11 controls the solenoid valve 3A, such that the first current value it is equal to an electric current value obtained by adding the specified current value α to the second current value i2.

If it is determined that the temperature Tb of the rechargeable battery 9 is equal to or greater than the first specified temperature (10° C.)(S15: NO), it is determined whether the temperature Tb of the rechargeable battery 9 is less than a third specified temperature (40° C. in the present embodiment) (S23).

If the temperature Tb of the rechargeable battery 9 is less than the third specified temperature (40° C.) (S23: YES), the opening degree of the solenoid valve 3A is adjusted, such that the FC output is equal to the external output (S25). Specifically, the control unit 11 controls the solenoid valve 3A such that the first current value it is equal to the second current value i2.

If it is determined that the temperature Tb of the rechargeable battery 9 is equal to or greater than the third specified temperature (40° C.) (S23: NO), it is determined whether the temperature Tb of the rechargeable battery 9 is less than a fourth specified temperature (45° C. in the present embodiment) (S27).

If the temperature Tb of the rechargeable battery 9 is less than the fourth specified temperature (45° C.) (S27: YES), the FC output is controlled such that: (a) the output power to be outputted from the fuel cell 5 is maintained to be equal to or less than a pre-set upper-limit power; and that (b) an absolute value of the battery output, i.e., an absolute value of electric power corresponding to a difference between output power outputted from the rechargeable battery 9 to the output unit 15 and the input power to be inputted to the rechargeable battery 9, is equal to or less than a pre-set upper-limit value.

Specifically, the control unit 11 controls the opening degree of the solenoid valve 3A such that the differential current value i3 is in a pre-set range (−β<i3<β) while the first current value it does not exceed a pre-set maximum output current value Io.

The maximum output current value Io is set based on a value of electric current which the fuel cell 5 can output. The aforementioned 13 has a value with which an increased amount of the temperature Tb of the rechargeable battery 9 can be zero or negative. The value of β varies depending on environmental requirements (such as an ambient temperature), a degree of degradation of the rechargeable battery 9, etc. and therefore, in the present embodiment, the value of β is determined by experiments, etc.

If the temperature Tb of the rechargeable battery 9 is equal to or greater than the fourth specified temperature (45° C.) (S27: NO), the process returns to S1. The temperature Tb of the rechargeable battery 9 continues to be equal to or greater than the fourth specified temperature (45° C.) and then, if the temperature Tb of the rechargeable battery 9 exceeds a fifth specified temperature (50° C. in the present embodiment) (S3: NO), the output unit 15 is stopped to stop the external output (S5), and also such stop is notified to the user.

3. Characteristics of the Power Supply Device According to the Present Embodiment

In the present embodiment, the rechargeable battery 9 is to be used in an appropriate temperature range (in the present embodiment, the range is greater than 0° C. and less than 50° C.). Thus, in the present embodiment, it is possible to inhibit a battery lifespan of the rechargeable battery 9 from being shortened.

Moreover, among the aforementioned appropriate temperature range, a temperature range from the first specified temperature (10° C.) or more to the third specified temperature (40° C.) or less is referred to as “optimal range”. If the rechargeable battery 9 according to the present embodiment is used in this optimal range, it is possible to further inhibit a battery lifespan of the rechargeable battery 9 from being shortened.

In view of the above, the present embodiment is configured as follows: if the temperature Tb of the rechargeable battery 9 is in the optimal range, two control modes (S19 and S21) are switched depending on the remaining energy of the rechargeable battery 9. Consequently, the temperature Tb of the rechargeable battery 9 can be maintained in the optimal range, while securing the necessary external output.

Specifically, if the remaining energy of the rechargeable battery 9 is greater than the specific remaining energy, the control mode is executed to reduce the input power to be lower than the input power when the temperature Tb of the rechargeable battery 9 is equal to or greater than the first specified temperature (10° C.) (S19).

On the other hand, if the remaining energy of the rechargeable battery 9 is equal to or less than the specific remaining energy, the control mode is executed to increase the input power to be greater than the input power when the temperature Tb of the rechargeable battery 9 is equal to or greater than the first specified temperature (10° C.) (S21).

In the present embodiment, if the temperature Tb of the rechargeable battery 9 is less than the second specified temperature (5° C.), the control mode is executed to make the input power be zero (S13). This increases electric power outputted from the rechargeable battery 9 and therefore, the temperature Tb of the rechargeable battery 9 can be increased to fall within the optimal range.

In the present embodiment, if the temperature Tb of the rechargeable battery 9 is equal to or greater than the first specified temperature (10° C.) and also is less than the third specified temperature (40° C.), the control mode (S25) is executed. In the control mode (S25), an amount of the input power is controlled, so as to control the output power to be outputted from the output unit 15.

With this configuration, in the present embodiment, it is possible to continue output of electric power to the external load, while inhibiting the temperature Tb of the rechargeable battery 9 from exceeding the upper limit of the optimal range.

In the present embodiment, if the temperature Tb of the rechargeable battery 9 exceeds the upper limit of the optimal range (i.e., the third specified temperature of 40° C.) and also is less than the fourth specified temperature (45° C.), the control mode (S29) is executed. In the control mode (S29), the output power to be outputted from the fuel cell 5 is made to be equal to or less than the pre-set upper-limit power, and also the battery output is made to be equal to or less than the pre-set upper-limit value.

With this configuration, in the present embodiment, it is possible to output electric power to the external load, while inhibiting the temperature Tb of the rechargeable battery 9 from reaching the upper limit of the appropriate temperature range (i.e., the fifth specified temperature of 50° C.).

In the present embodiment, the control unit 11 comprises a control mode in which if the detected temperature T1 is greater than the fifth specified temperature (50° C.) that is pre-set to be higher than the fourth specified temperature (45° C.), the input power is made to be zero.

By this configuration, in the present embodiment, it is possible to inhibit the temperature Tb of the rechargeable battery 9 from exceeding the upper limit of the appropriate temperature range (i.e., the fifth specified temperature of 50° C.); therefore, a battery lifespan of the rechargeable battery 9 can be inhibited from being shortened.

### Second Embodiment

In the above-described embodiment, the FC output is controlled based on the temperature Tb of the rechargeable battery 9. However, in the present embodiment, the FC output is controlled based on a voltage of the rechargeable battery 9.

1. Output Control of the Fuel cell, etc.

The control unit 11 executes a control mode to maintain the voltage of the rechargeable battery 9 to be in a specified voltage range (for example, 4.0V or more, and 4.1V or less). Specifically, the control unit 11 controls, based on a detected voltage V1 detected by the voltmeter 11D, at least one electric power of the input power to be inputted to the rechargeable battery 9 from the fuel cell 5 and the output power to be outputted from the rechargeable battery 9.

As in the first embodiment, the power supply device 1 according to the present embodiment indirectly controls at least one of the input power to be inputted to the rechargeable battery 9 from the fuel cell 5 and the output power to be outputted from the rechargeable battery 9, by adjusting the opening degree of the solenoid valve 3A, i.e., an amount of the fuel to be supplied to the fuel cell 5.

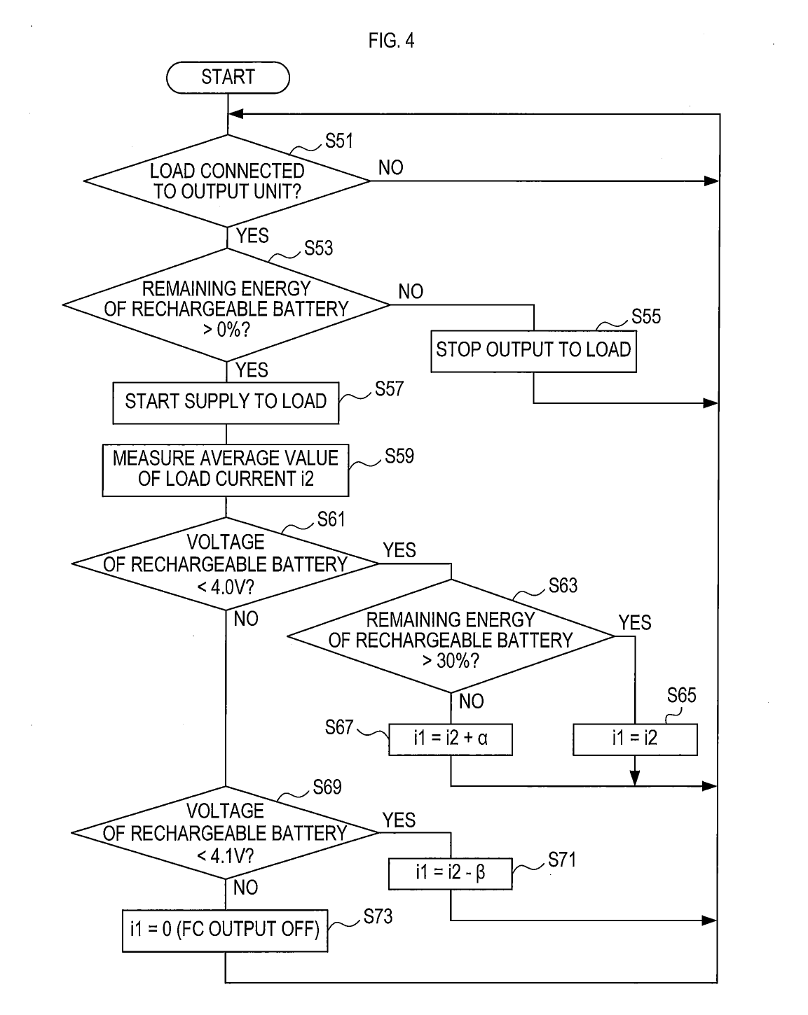

The flowchart in FIG. 4 shows a control (hereinafter, referred to as “power-supply control”). A program for this power-supply control is pre-stored in the aforementioned non-volatile memory unit. When the CPU 111 reads the program for the power-supply control upon turn-on of the activation switch of the power supply device 1, the program for the power-supply control is started. When the activation switch is interrupted, at that point in time, execution of the program for the power-supply control is stopped.

When the power-supply control program is started, it is determined whether an external load such as an electric power tool is connected to the output unit 15, in other words, whether the external output is being outputted (S51). If the external output is not being outputted (S51: NO), the step of S51 is carried out again and the power supply device 1 is made to be in a standby state.

If it is determined that the external output is being outputted (S51: YES), it is determined whether the remaining energy of the rechargeable battery 9 is greater than 0% by using the detected voltage V1 of the voltmeter 11D (S53).

If it is determined that the remaining energy of the rechargeable battery 9 is 0% (S53: NO), the output unit 15 is stopped to stop the external output (S55), and such stop is notified to the user.

If it is determined that the remaining energy of the rechargeable battery 9 is greater than 0% (S53: YES), the external output is outputted to supply electric power to the external load (S57); also, an average value of the second current value i2, i.e., the external output, is detected (S59).

Next, the control unit 11 determines whether the voltage of the rechargeable battery 9 is less than a first specified voltage (4.1V in the present embodiment), and whether the voltage of the rechargeable battery 9 is less than a pre-set second specified voltage (4.0V in the present embodiment), in the following manner.

It is determined whether the voltage of the rechargeable battery 9 is less than the second specified voltage (4.0V) (S61). If it is determined that the voltage of the rechargeable battery 9 is less than the second specified voltage (4.0V) (S61: YES), it is determined whether the remaining energy of the rechargeable battery 9 is greater than a pre-set specific remaining energy (for example, 30%) (S63).

If it is determined that the remaining energy of the rechargeable battery 9 is greater than the specific remaining energy (S63: YES), the opening degree of the solenoid valve 3A is adjusted, such that the FC output is equal to the external output (S65). Specifically, the control unit 11 controls the solenoid valve 3A such that the first current value it is equal to the second current value i2.

If it is determined that the remaining energy of the rechargeable battery 9 is equal to or less than the specific remaining energy (S63: NO), the opening degree of the solenoid valve 3A is adjusted, such that the input power to be inputted to the rechargeable battery 9 is equal to electric power obtained by adding the specified electric power to the current output power (S67). Specifically, the control unit 11 controls the solenoid valve 3A such that the first current value it is equal to an electric current value obtained by adding the specified current value α to the second current value i2.

If it is determined that the voltage of the rechargeable battery 9 is equal to or more than the second specified voltage (4.0V) (S61: NO), it is determined whether the voltage of the rechargeable battery 9 is less than the first specified voltage (4.1V) (S69) that is greater than the second specified voltage (4.0V).

If it is determined that the voltage of the rechargeable battery 9 is less than the first specified voltage (4.1V)(S69: YES), the opening degree of the solenoid valve 3A is adjusted, such that the FC output, i.e., the input power to be inputted to the rechargeable battery 9, is equal to electric power obtained by subtracting the specified electric power from the current output power (S71). Specifically, the control unit 11 controls the solenoid valve 3A, such that the first current value it is equal to an electric current value obtained by subtracting a specified current value 13 from the second current value i2.

If it is determined that the voltage of the rechargeable battery 9 is equal to or more than the first specified voltage (4.1V) (S69: NO), the solenoid valve 3A is closed to stop fuel supply to the fuel cell 5, thereby stopping the supply of electric power to the rechargeable battery 9 from the fuel cell 5 (S73).

In S73, the supply of electric power from the fuel cell 5 stops and thus, only the rechargeable battery 9 supplies electric power to the external load. For this reason, the battery output increases, and the voltage of the rechargeable battery 9, i.e., the remaining energy of the rechargeable battery 9, gradually decreases.

2. Characteristics of the Power Supply Device According to the Present Embodiment

In the present embodiment, if the voltage of the rechargeable battery 9 is greater than the pre-set first specified voltage (4.1V), the control mode (S71) is executed to reduce the FC output to be less than the FC output when the voltage of the rechargeable battery 9 is equal to or less than the first specified voltage (4.1V).

With this configuration, it is possible to inhibit increase of the temperature Tb of the rechargeable battery 9, and also to inhibit the rechargeable battery 9 from being overcharged. Consequently, a battery lifespan of the rechargeable battery 9 can be inhibited from being shortened.

In the present embodiment, if the voltage of the rechargeable battery 9 is greater than the first specified voltage (4.1V), the control mode (S73) is executed to make the input power to be zero. This can inhibit overcharge of the rechargeable battery 9. Moreover, a battery lifespan of the rechargeable battery 9 can be inhibited from being shortened.

In the present embodiment, the first specified voltage corresponds to an upper-limit voltage of the specified voltage range, and the second specified voltage corresponds to a lower-limit voltage of the specified voltage range.

### Third Embodiment

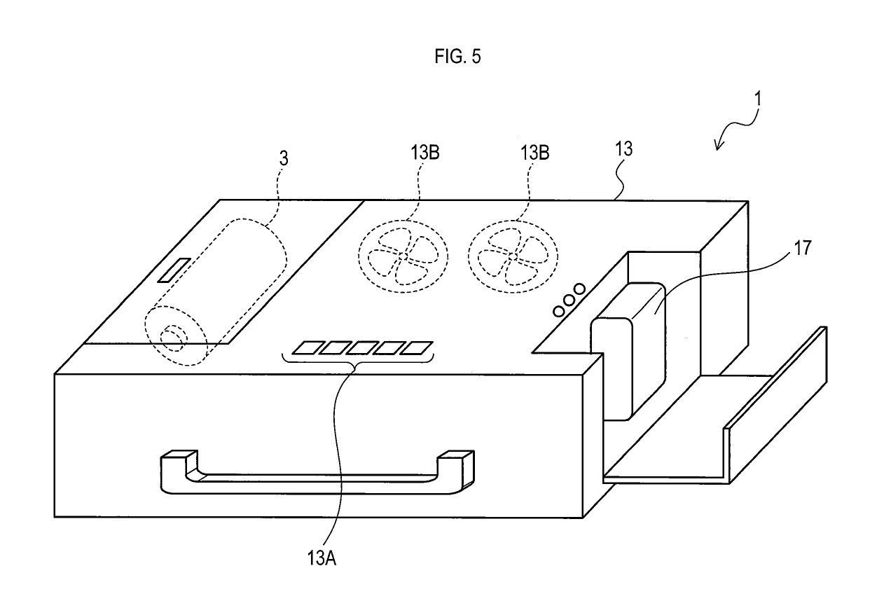

As shown in FIG. 5, the present embodiment is configured such that a battery pack 17 can be connected to the output unit 15. Here, the battery pack 17 is a power source that is detachably attached to an electric power tool.

### Fourth Embodiment

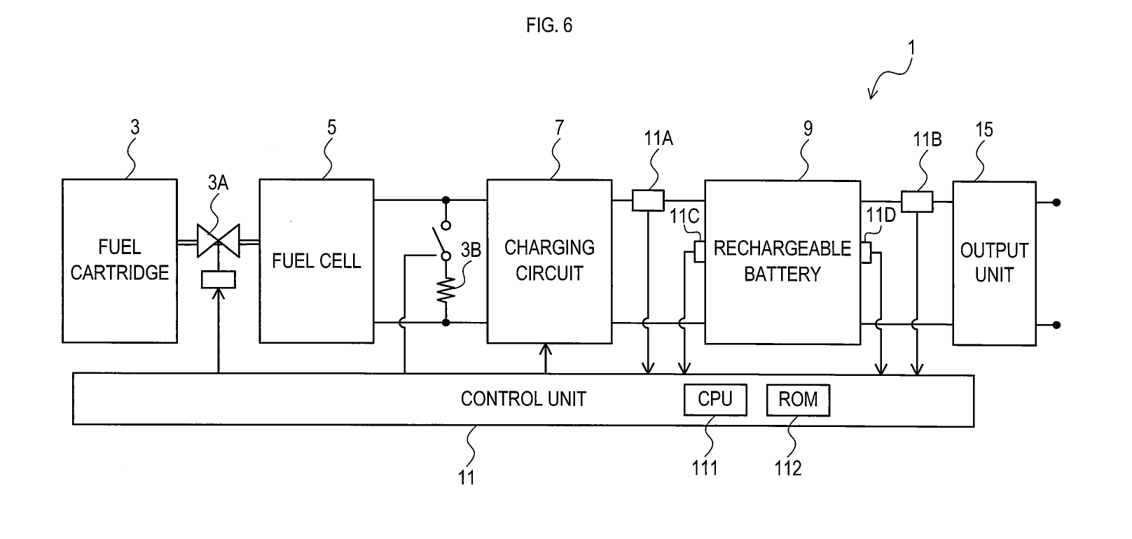

In the above-described embodiments, an amount of the fuel to be supplied to the fuel cell 5 is adjusted by the solenoid valve 3A, thereby controlling the FC output. However, in the present embodiment, as shown in FIG. 6, the FC output is consumed by an electrical resistance 3B, etc., and a consumed amount in the electrical resistance 3B is adjusted by the control unit 11, thereby controlling the input power to be inputted to the rechargeable battery 9.

Specifically, as the consumed amount in the electrical resistance 3B becomes larger, the input power to be inputted to the rechargeable battery 9 becomes smaller. On the other hand, as the consumed amount in the electrical resistance 3B becomes smaller, the input power to be inputted to the rechargeable battery 9 becomes larger.

In FIG. 6, the solenoid valve 3A is provided; both the solenoid valve 3A and the electrical resistance 3B may be used to control the input power to be inputted to the rechargeable battery 9. As in the control unit 11 shown in FIG. 1, the control unit 11 in FIG. 6 comprises the CPU 111, and ROM 112.

### Fifth Embodiment

In the above-described embodiments, when the temperature Tb of the rechargeable battery 9 is in the optimal range (from 10° C. to 40° C.), or when the voltage of the rechargeable battery 9 is in the optimal range (from 4.0V to 4.1V), electric power requested from the external load is outputted from the output unit 15. However, the present embodiment is configured to control a possible maximum of the external output (hereinafter, referred to as “maximum external output”) depending on the remaining energy of the rechargeable battery 9.

1. Details of Control

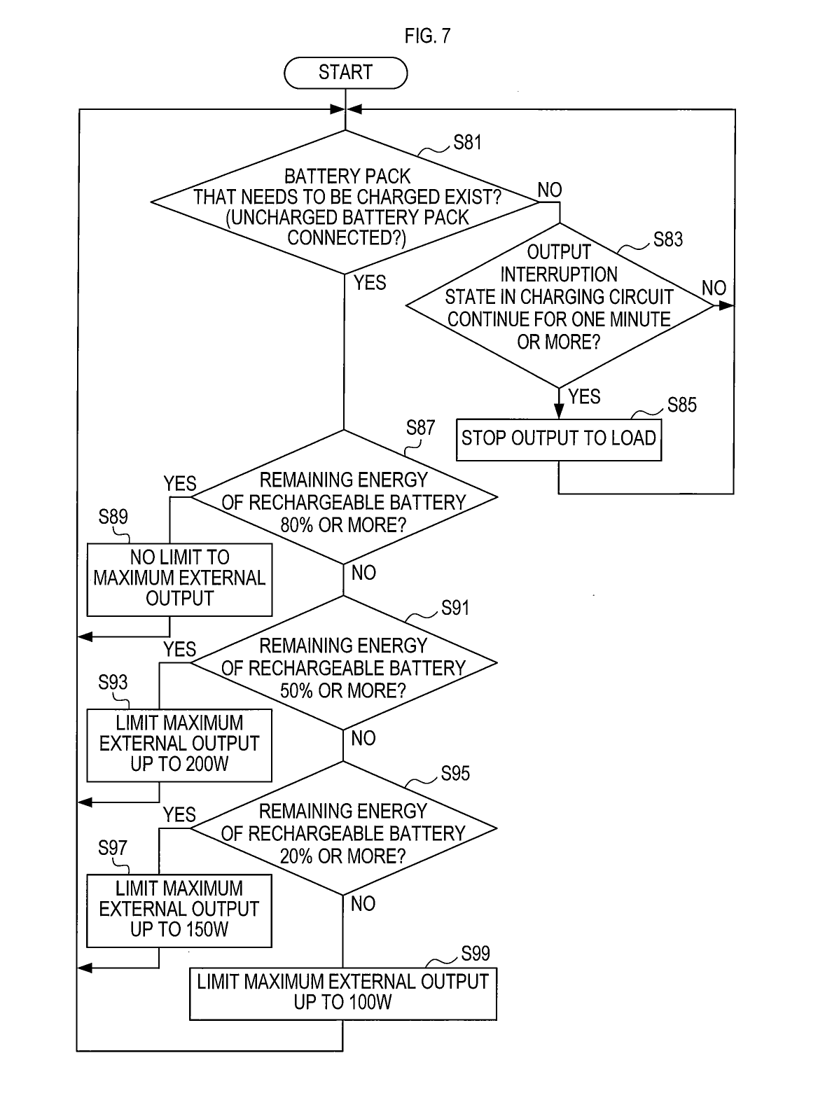

FIG. 7 shows a control in a case where the present embodiment is applied to the power supply device 1 according to the fourth embodiment. As shown in FIG. 7, firstly, it is determined whether the battery pack 17 that needs to be charged or the battery pack 17 that is uncharged is connected to the output unit 15 (S81). Hereinafter, the battery pack 17 that needs to be charged and the battery pack 17 that is uncharged are referred to as “the battery pack 17 that needs to be charged, etc.”

If it is determined that the battery pack 17 that needs to be charged, etc.

are not connected (S81: NO), it is determined whether an output interruption state in a charging circuit (not shown) provided in the power supply device 1 continues for or longer than a specified time period (for example, one minute) (S83).

If it is determined that the output interruption state continues for or longer than the specified time period (S83: YES), the output unit 15 and the charging circuit are stopped, and also, fuel supply to the fuel cell 5 is stopped (S85). However, if it is determined that the output interruption state does not continue for or longer than the specified time period (S83: NO), the step of S81 is executed.

On the other hand, if it is determined that the battery pack 17 that needs to be charged, etc. are connected (S81: YES), it is determined whether the remaining energy of the rechargeable battery 9 is 80% or more (S87). If it is determined that the remaining energy of the rechargeable battery 9 is 80% or more (S87: YES), electric power requested from the external load can be outputted without limiting the maximum external output (S89).

If it is determined that the remaining energy of the rechargeable battery 9 is less than 80% (S87: NO), it is determined whether the remaining energy of the rechargeable battery 9 is 50% or more (S91). If it is determined that the remaining energy of the rechargeable battery 9 is 50% or more (S91: YES), the maximum external output is limited to a first output (for example, 200W) or below (S93).

However, if it is determined that the remaining energy of the rechargeable battery 9 is less than 50% (S91: NO), it is determined whether the remaining energy of the rechargeable battery 9 is 20% or more (S95). If it is determined that the remaining energy of the rechargeable battery 9 is 20% or more (S95: YES), the maximum external output is limited to a second output (for example, 150W) or below (S97).

However, if it is determined that the remaining energy of the rechargeable battery 9 is less than 20% (S95: NO), the maximum external output is limited to a third output (for example, 100W) or below (S99).

2. Characteristics of the Power Supply Device According to the Present Embodiment

In the present embodiment, the maximum external output of the power supply device 1 is controlled depending on the remaining energy of the rechargeable battery 9, and therefore, it is possible to inhibit failures arising from shortage of the remaining energy in the rechargeable battery 9 before such failures would occur.

### Other Embodiment

Since the present invention relates to a power supply deice, there is no limitation on a type of equipment that operates by receiving power supply from the power supply deice according to the present invention.

For use in outdoor environment, the power supply device 1 according to the present embodiments is configured to be waterproof or to enable placement of the power supply device 1 on an inclined surface, etc. However, the present invention should not be limited to such configurations, and can be applied to a power supply device designed to be used only for indoors.

In the above-described embodiments, it is configured that fuel is filled in the detachable fuel cartridge 3. However, the present invention should not be limited to this configuration, and for example, the present invention can be applied to a stationary power supply device that supplies fuel via pipes.

Although the fuel cell 5 according to the above-described embodiments is a direct methanol fuel cell, the present invention should not be limited to this configuration; the fuel cell 5 may be other type of a fuel cell.

Moreover, the rechargeable battery 9 according to the above-described embodiments is a lithium-ion battery; however, the present invention should not be limited to this configuration. The rechargeable battery 9 may be other type of a rechargeable battery.

In addition, in the above-described embodiments, the FC output, i.e., an amount of the fuel to be supplied to the fuel cell 5, is controlled, thereby indirectly controlling electric power (battery output) to be outputted from the rechargeable battery 9. However, the present invention should not be limited to this configuration; the battery output may be directly controlled.

In the above-described embodiments, electric power is controlled by controlling an electric current value. However, the present invention should not be limited to this configuration; electric power may be controlled by controlling a voltage value, or controlling both a voltage value and a current value.

Furthermore, although the control unit in the above-described embodiments is configured with a microcomputer comprising a CPU, or a CPU and others, the control unit may be configured with a separate electronic circuit or an ASIC.

The present invention should not be limited to the above-described embodiments, and may include a configuration that conforms with the main idea of the invention described in the claims.

What is claimed is:

1. A power supply device comprising:
a fuel cell configured to generate electric power by causing an oxidation reaction between a fuel and an oxidant;
a rechargeable battery that is chargeable and dischargeable;
a temperature detection unit configured to detect a temperature of the rechargeable battery;
an output unit configured to externally output electric power; and
a control unit configured to be capable of controlling at least one electric power of an input power to be inputted to the rechargeable battery from the fuel cell and an output power to be outputted from the rechargeable battery, based on a detected temperature detected by the temperature detection unit.

2. The power supply device according to claim 1,
wherein the control unit comprises a control mode in which if the detected temperature is less than a pre-set first specified temperature, the input power is reduced lower than the input power in a case where the detected temperature is equal to or greater than the first specified temperature.

3. The power supply device according to claim 1,
wherein the control unit comprises a control mode in which if the detected temperature is less than a pre-set first specified temperature, the input power is increased greater than the input power in a case where the detected temperature is equal to or greater than the first specified temperature.

4. The power supply device according to claim 1,
wherein the control unit comprises a control mode and a different control mode:
in the control mode, if the detected temperature is less than a pre-set first specified temperature and a remaining energy of the rechargeable battery is greater than a specific remaining energy that is specified beforehand, the input power is reduced lower than the input power in a case where the detected temperature is equal to or greater than the first specified temperature; and
in the different control mode, if the detected temperature is less than the pre-set first specified temperature and the remaining energy of the rechargeable battery is equal to or less than the specific remaining energy, the input power is increased greater than the input power in a case where the detected temperature is equal to or greater than the first specified temperature.

5. The power supply device according to claim 2,
wherein the control unit comprises a control mode in which if the detected temperature is less than a second specified temperature that is pre-set to be lower than the first specified temperature, the input power is made to be zero.

6. The power supply device according to claim 2,
wherein the control unit comprises a control mode in which if the detected temperature is less than a third specified temperature that is pre-set to be higher than the first specified temperature, an amount of the input power is controlled so as to control an output power to be outputted from the output unit.

7. The power supply device according to claim 6,
wherein the control unit comprises a control mode in which if the detected temperature is less than a fourth specified temperature that is pre-set to be higher than the third specified temperature, the output power to be outputted from the fuel cell is controlled such that the output power to be outputted from the fuel cell is equal to or less than a pre-set upper-limit power, and that one of the output power to be outputted to the output unit from the rechargeable battery and the input power to be inputted to the rechargeable battery is equal to or less than a pre-set upper-limit value.

8. The power supply device according to claim 7,
wherein the control unit comprises a control mode in which if the detected temperature is greater than a fifth specified temperature that is pre-set to be higher than the third specified temperature, the input power is made to be zero.

9. The power supply device according to claim 1,
wherein the control unit is configured to control the input power by adjusting an amount of the fuel to be supplied to the fuel cell.

10. A power supply device comprising:
a fuel cell configured to generate electric power by causing an oxidation reaction between a fuel and an oxidant;
a rechargeable battery that is chargeable and dischargeable;
a voltage detection unit configured to detect a voltage of the rechargeable battery;
an output unit configured to externally output electric power; and
a control unit comprising a control mode in which if a detected voltage detected by the voltage detection unit is higher than a pre-set first specified voltage, an input power to be inputted to the rechargeable battery from the fuel cell is reduced lower than the input power in a case where the detected voltage is equal to or less than the first specified voltage.

11. The power supply device according to claim 10,
wherein the control unit comprises a control mode in which if the detected voltage is higher than the first specified voltage, the input power is made to be zero.

12. The power supply device according to claim 10,
wherein the control unit is configured to control the input power by adjusting an amount of the fuel to be supplied to the fuel cell.
